(19) United States
(12) Patent Application Publication
(10) Pub. No.: US 2022/0358095 A1
(43) Pub. Date: Nov. 10, 2022

(54) MANAGING DATA REQUESTS TO A DATA SHARD

(71) Applicant: Shreyas JAIN, Cupertino, CA (US)

(72) Inventor: Shreyas JAIN, Cupertino, CA (US)

(21) Appl. No.: 17/302,684

(22) Filed: May 10, 2021

(51) Int. Cl. G06F 16/182; G06F 16/955; G06F 16/13

(52) U.S. Cl. CPC G06F 16/182; G06F 16/955; G06F 16/134

(57) ABSTRACT

Examples for managing requests to a data shard, are described. In an example, incoming data being stored in a first data shard within a first set of data shards may be monitored. Based on the monitoring, a second data shard within a second set of data shards may be identified. In an example, the second data shard may correspond to the first data shard. Thereafter, an identifier of the second data shard may be associated with to the first data shard. Once associated with the first data shard, subsequent data requests corresponding to the retrieved identifier may be redirected to the first data shard.

### BACKGROUND

Modern data systems rely include networked computing and data systems which enable storing, searching or retrieving data, that may be stored in data repositories and data warehouses. Such data may be stored across distributed data storages that may span across multiple locations. The stored data may be subject to different operations in order to make data suitable for analysis. Thereafter, the data may be subject to querying or analysis based on a variety of rules. The data in the data storages may be obtained from a number of homogeneous or heterogeneous sources. Such data may be periodically refreshed to ensure that the insights or the analysis are current.

### BRIEF DESCRIPTION OF DRAWINGS

The detailed description is provided with reference to the accompanying figures, wherein:

FIG. 1 illustrates a system to manage a data request directed to a data shard, according to an example;

FIG. 2 illustrates a block diagram of a system to manage a data request directed to a data shard, according to another example;

FIG. 3 illustrates another block diagram depicting states of data shards within a first set of data shards and a second set of data shards, according to an example;

FIG. 4 illustrates a method for managing a data request directed to a data shard, according to an example; and

FIG. 5 illustrates a non-transitory computer readable medium for managing a data request to a data shard, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Data systems enable storage of large volumes of data which may then be analyzed for providing insights, for example, for a variety of business-related objectives. Owing to advancements in information technology and complexity of businesses (and related operations), the volume of data that is generated as a result of such operations has increased tremendously. Analysis of such data may offer critical insights which may then be utilized for increasing the efficiencies of operations.

Since the volume of data under consideration may be considerably large, analysis of such large volumes of data may also pose numerous challenges. For efficient organization (and therefore efficient analysis), data within databases may be distributed as a database shard. Database shards (hereinafter referred to as data shards) may be considered as logical distribution of one or more data items stored in the storage network. Each shard may have an associated data storage device and/or an associated data storage volume. The data shards may be created based on a predefined criteria or predefined logic. Examples of such predefined criteria or logic may include, but are not limited to, nature of business, name of an organization, and geographical location of source from which the data may have originated. It may be noted that such examples are only indicative. Other examples of such predefined criteria may also be relied on without deviating from the scope of the present subject matter. It may also be noted that the data stored may be processed before it may be stored within the data shards. For example, the data may be formatted such that it conforms to technical specification and requirements of the servers on which the data shards may be eventually stored or may be processed such that it adheres to one or more business objectives.

It is pertinent to note that the data may be sourced from a plurality of data sources. For example, various systems or operations within an organization may be continuously generating data which may be then eventually stored within data shards for analysis. In the present context, performing analysis on most recent or updated data is preferred such that the insights or analysis are as current as possible or are performed in real-time. Since the amount of data that may be generated and is generally available for analysis is being constantly generated, the data within the data shards may have to be periodically updated.

In relation to the above context, updating the data in the data shards may require that the data system be put in an offline mode during which no analysis onto the data is performed. In such instance, access to the analyses or the data may not be possible since the data itself is being updated. During such intervals, the system may be down for maintenance. Although such procedures are implemented when the likelihood of users attempting to access the data is less, it nevertheless results in situations wherein users may have to either rely on analyses which may be based on previous versions of data or may have to wait till the data system is back online. Such instances particularly in the context of data services, involving storing, searching or retrieving data, is not desired.

Approaches for updating data within data shards in a data system, are described in the description which follows and what has been provided in conjunction with the accompanying figures. In an example, the data system may maintain and manage access to a first data shard and a second data shard. The first data shard may be one of plurality of data shards within a first set of data shards, whereas the second data shard may be one of plurality of data shards within a second set of data shards. In the present example, the analyses or insights may be derived based on the data which is stored within the second set of data shards. On the other hand, the data shards within the first set of data shards may be such that they are in communication with one or more data sources which may be constantly generating data. Data from such sources may be obtained and stored within the data shards present within the first set of data shards.

In an example, the data shards within the first set of data shards correspond to the data shards within the second set of data shards. For example, the first data shard within the first set may correspond to the second data shard which may be one of the data shards in the second set. It may be noted that it is not necessary that the first data shard may be associated with only the second data shard. Any number of data shards of the first set of data shards may be associated with any number of data shards in the second set of data shards.

In operation, the data being retrieved from various data sources and stored within the first set of data shards may be monitored. The monitoring of the data shards within the first set of data shards may be based on a defined criterion. In an example, the monitoring may be implemented through an artificial-intelligence based machine learning model based on a plurality of dimensions or criteria. Examples of such dimensions may include, but is not limited to, nature of business, name of an organization, and geographical location. Other mechanisms and parameters for monitoring the state of the first data shard may be used without deviating from the present subject matter. Returning to the present example, on ascertaining that the state of one or more data shards within the first set of data shards (say the first data shard) conforms to the defined criteria, one or more data shards from the second set of data shards (say the second data shard) corresponding to the first data shard may be determined.

Once the second data shard is determined, the identifier of the second data shard may be obtained. Thereafter, the identifier corresponding to the second data shard may be associated with the first data shard. Once the first data shard is associated (i.e., renamed) with the identifier of the second data shard, the second data shard may be backed up and then subsequently deleted. Since the first data shard is now identifiable by the identifier previously associated with the second data shard, subsequent data requests intended for the second data shard are directed to the first data shard. As a result, any querying or analyses based on the second data shard is now performed based on the updated data which is now available in the first data shard. A data request may be considered as any executable command or instructions which may either store, search, or retrieve data that may be stored in one or more data shards. Although the present approaches have been described with respect to the first data shard and the second data shard within the first set of data shards and the second set of data shards, respectively, the same may be implemented for any number of data shards within the first data shard. Consequently, a plurality of defined conditions may be monitored for different data shards within the first set of data shards.

As may be understood, the present subject matter provides a number of distinct technical advantages. Since data requests are directed to the first data shard (which is now renamed as per the identifier of the second data shard), the transition to the updated data shards is immediate and without any delay. Furthermore, such an updating of the data shards is also done without the data system transitioned between an offline and online state. The above-described approaches may be implemented seamlessly without the need for any new or specific hardware. It is again iterated that the above examples are only indicative of how the present subject matter may be implemented within a computing or a networked environment. The approaches are possible to implement through other examples without impacting the scope of the accompanying claims in any manner.

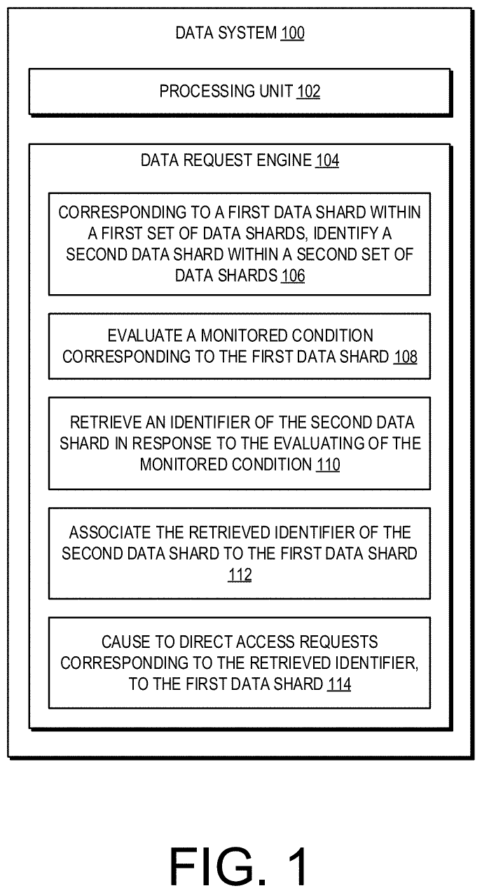

The manner in which an example data system may be implemented are explained in detail with respect to FIGS. 1-5. While aspects of described data systems may be implemented in any number of different computing devices, networked environments, and/or implementations, the examples are described in the context of the following example system(s). It may be noted that drawings of the present subject matter shown here are for illustrative purposes and are not to be construed as limiting the scope of the subject matter claimed.

FIG. 1 illustrates a data system 100 comprising a processing unit 102 and a data request engine 104 which may be coupled to the processing unit 102. The data request engine 104, amongst other functions, manages data requests in the context of a first data shard and a second data shard, within a first set of data shards and a second set of data shards (not shown in FIG. 1), respectively. As described previously, the analyses or insights may be derived based on the data which is stored within the second set of data shards. On the other hand, the data shards within the first set of data shards may be such that they are in communication with one or more data sources which may be constantly generating data. Data from such sources may be obtained and stored within the data shards present within the first set of data shards.

In operation, the data request engine 104 may, for a given first data shard, identify a corresponding second data shard. While the second data shard is identified, the data request engine 104 may evaluate a monitored condition with respect to the first data shard. Based on the evaluating of the monitored condition, the data request engine 104 may determine an identifier corresponding to the second data shard. For example, the data request engine 104 may determine the identifier of the second data shard in response to determining that the monitored condition satisfies a defined criterion. On determining the defined criteria to have been met, the data request engine 104 may associate the identifier retrieved from the second data shard with the first data shard. Once the identifier is associated with the first data shard, data requests intended for the second data shard are directed to the first data shard. As may be noted, any querying or analyses based on the second data shard is now performed based on the updated data which is now available in the first data shard.

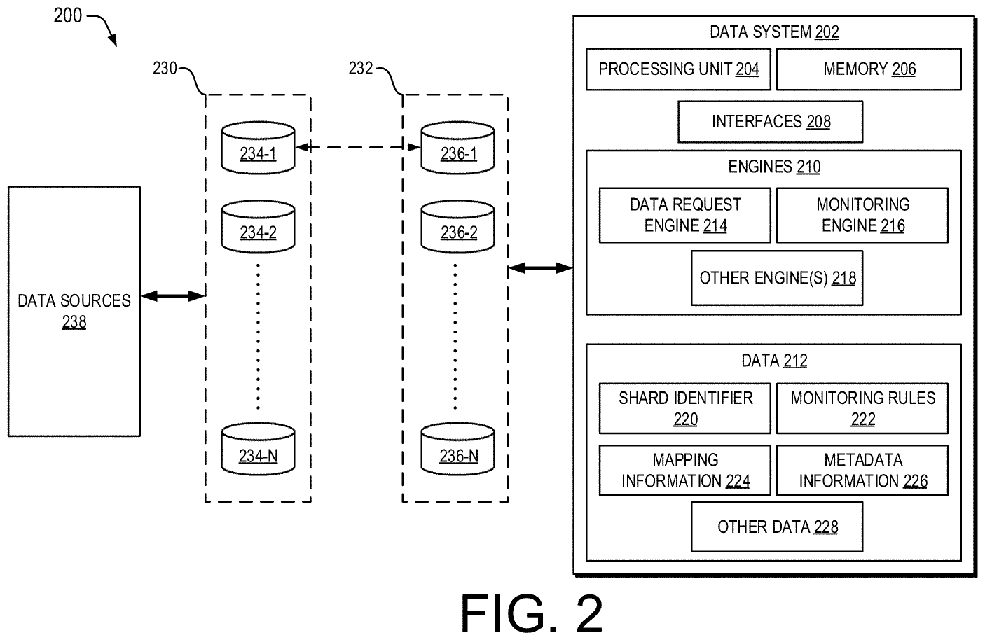

FIG. 2 illustrates a networked environment 200 implementing approaches for managing data requests directed to data shards. In an example, the networked environment 200 comprises a data system 202. The data system 202 (hereinafter referred to as system 202) may further include a processing unit 204. The processing unit 204 may be implemented as a microprocessor, microcomputer, microcontroller, digital signal processor, central processing unit, state machine, logic circuitry, and/or any device that may manipulate signals based on operational instructions. The processing unit 204 may be a single computational unit or may include multiple such computational units, without deviating from the scope of the present subject matter.

The system 202 may further include memory 206, and interfaces 208. The interfaces 208 may include a variety of software and hardware interfaces that allow the system 202 to interact with other networked storages or networked devices, such as network entities, web servers, and external repositories, and peripheral devices such as input/output (I/O) devices (not shown in FIG. 2 for sake of brevity). In another example, the interfaces 208 may also enable the communication between the processing unit 204, the memory 206 and other components of the system 202. voltage regulator 204 and the cooling device(s) 206. The memory 206 may include any computer-readable medium known in the art including, for example, volatile memory, such as Static Random-Access Memory (SRAM) and Dynamic Random-Access Memory (DRAM), and/or non-volatile memory, such as Read-Only Memory (ROM), Erasable Programmable ROMs (EPROMs), flash memories, hard disks, optical disks, and magnetic tapes.

The system 202 may further include engines 210 and data 212. The engines 210 may be implemented as a combination of hardware and programming, for example, programmable instructions to implement a variety of functionalities of the engines 210. In examples described herein, such combinations of hardware and programming may be implemented in several different ways. For example, when implemented as a hardware, the engines 210 may be a microcontroller, embedded controller, or super I/O-based integrated circuits. The programming for the engines 210 may be executable instructions. Such instructions may be stored on a non-transitory machine-readable storage medium which may be coupled either directly with the system 202 or indirectly (for example, through networked means). In an example, the engines 210 may include a processing resource, for example, either a single processor or a combination of multiple processors, to execute such instructions. In the present examples, the non-transitory machine-readable storage medium may store instructions that, when executed by the processing resource, implement engines 210. In other examples, the engines 210 may be implemented as electronic circuitry.

The engines 210 in turn may include the data access engine 214, monitoring engine 216 and other engine(s) 218. The data access engine 214 may be similar to the data request engine 104 as discussed in conjunction with FIG. 1. The other engine(s) 218 may further implement functionalities that supplement applications or functions performed by the system 202 or any of the engines 210. The data 212, on the other hand, includes data that is either stored or generated as a result of functionalities implemented by any of the engines 210 or the system 202. It may be further noted that information stored and available in the data 212 may be utilized by the engines 210 for performing various functions by the system 202. In an example, data 212 may include shard identifiers 220, monitoring rules 222, mapping information 224, metadata information 226 and other data 228. The mapping information 224, amongst other things, may map different types of data to the data shard and serve as a basis for classifying incoming data into one or more data shards. The metadata information 226 may include prescribed rules, user defined parameters, network monitoring data or performance data of the data shards. The present approaches may be applicable to other examples without deviating from the scope of the present subject matter. It may be noted that the blocks representing engines 210 and data 212 are indicated as being within the system 202 for sake of explanation only. Any one or more blocks within engines 210 and data 212 may be implemented as separate blocks outside the system 202.

The networked environment 200 may further include a first set of data shards 230 (referred to as the first set 230) and a second set of data shards 232 (referred to as the second set 232). The first set 230 may further include a plurality of data shards 234-1, 2, . . . , N (collectively referred to as data shards 234). In a similar manner, the second set 232 may further include a plurality of data shards 236-1, 2, . . . , N (collectively referred to as data shards 236). In the present example as illustrated, one or more of the data shards 234 may correspond to one or more of the data shards 236. Furthermore, the second set 232 may be such that it is in communication with the system 202 for processing queries or data requests that may be received from users over a communication network (not shown in FIG. 2). The first set 230 on the other and, may not be in communication with the system 202, but may be in communication with one or more data sources 238. The data sources 238 may be combination of data sources which may continuously generate and provide data to the first set 230.

The data shards 234, 236 may be considered as logical distribution of one or more data items stored in the storage network. The logical distribution of data to result in the data shards 234, 236 may be based on a predefined criteria or predefined logic. Examples of such predefined criteria or logic may include, but are not limited to, nature of business, name of an organization, and geographical location of source from which the data may have originated. It may be noted that such examples are only indicative. Other examples of such predefined criteria may also be relied on without deviating from the scope of the present subject matter. Although not represented in FIG. 2, the data shards 234, 236 may further include a plurality of sub-shards. In another example, the data shards 234, 236 may further include further sub-divisions. Such an implementation would also be included within the scope of the accompanying claims.

The data sources 238 may be continuously generating data. Such data may be generated as a result of the execution of one or more business operations of an organization. Such data may then be processed based on the predefined criteria or logic to segregate data into one or more data shards, such as the data shards 234. In the context of the present subject matter, user initiated querying and analysis is performed on the data shards 236 whereas any additional data from various data sources 238 is obtained and stored in the data shards 234. The various approaches are not explained with respect to the first data shard 234-1 and the second data shard 236-1. In this example, the first data shard 234-1 corresponds to the second data shard 236-1. A certain data shard corresponding to another data shard may imply that both such data shards may be based or derived based on similar or same predefined criteria or logic. Any other parameters may also be considered while determining that one or more data shards correspond to such other data shards.

In operation, the monitoring engine 216 may monitor a state of data within the first data shard 234-1. Monitoring the state of the data within the first data shard 234-1 may entail evaluating the amount of data stored or evaluating incoming data from one or more of the data sources 238 based on one or more criteria. In an example, such criteria may be specified through the metadata information 226. The metadata information 226 may include prescribed rules, user defined parameters, network monitoring data or performance data of the first data shard 234-1. Examples of such criteria may include, but are not limited to, volume of incoming data, frequency at which new data instances are registered, name of organization pertaining to a specific organization, data originating from a predefined geographic location.

Returning to the present example, the monitoring engine 216 may determine whether any one or more of the specified conditions as provided in the metadata information 226 are met by the incoming data being obtained from the data sources 238 and collected continuously the first data shard 234-1. For example, the monitoring engine 216 may ascertain whether the volume of data which has been stored within the first data shard 234-1 has exceeded the threshold limits that may have been described within the metadata information 226. In a similar example, the monitoring engine 216 may also monitor whether the data being continuously stored within the first data shard 234-1 pertains to specific organization (which again may be specified in the metadata information 226). In this manner, the monitoring engine 216 may determine whether one or more other conditions specified in the metadata information 226 are met or not. In an example, the monitoring engine 216 may monitor the incoming data across all data shards within the first set 230 and the second set 232 by considering the mapping information 224 to identify the appropriate data shards within the first set 230 in which the data may be continuously stored.

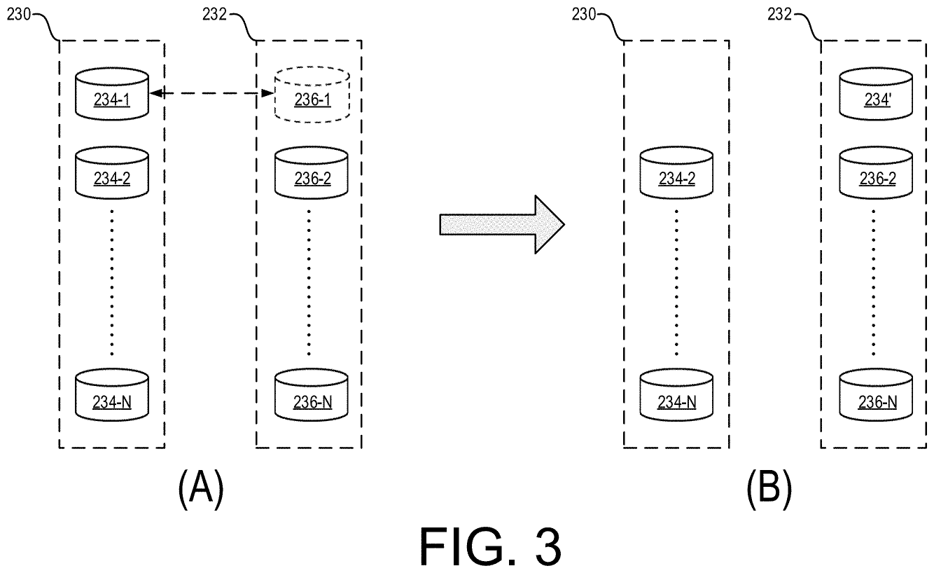

Returning to the present example, on determining that the conditions in the metadata information 226 matches the state of data within the first data shard 234-1, the data access engine 214 may further initiate subsequent steps for managing data request to the data shards (e.g., the first data shard 234-1 or the second data shard 236-1) within the first set 230 and the second set 232. These steps are further described with reference to FIGS. 3A-3B.

On determining that the conditions provided in the metadata information 226 have been met by the state of data within the first data shard 234-1, the data access engine 214 may initially obtain the identifiers corresponding to the first data shard 234-1 and the second data shard 236-1. In an example, the identifiers of the first data shard 234-1 and the second data shard 236-1 may be obtained from the shard identifiers 220. Once the respective shard identifiers 220 are obtained, the second data shard 236-1 may be backed up. With the second data shard 236-1 backed up, second data shard 236-1 may be subsequently deleted (as depicted in FIG. 3A). As illustrated in FIG. 3A, the second data shard 236-1 is now deleted (depicted in dotted line).

With the second data shard 236-1 now deleted, the data access engine 214 may obtain the identifier corresponding to the second data shard 236-1 (which is now deleted as indicated by the dotted lines) and associates the same with the first data shard 234-1. In an example, the first data shard 234-1 with the identifier of the previously available second data shard 236-1 may then be logically included as part of the second set 232. The first data shard 234-1 which is now renamed based on the identifier of the second data shard 236-1, is depicted as data shard 234′. Once renamed, the data access engine 214 may begin routing data requests to the data shard 234′. The data shard 234′ (which bears the identifier of the previously present second data shard 236-1) includes data which is updated when considered with respect to the data which was available within the second data shard 236-1. In this manner, data within any one or more of the second set 232 may be updated based the data which may have been continuously collected in the data shards of the first set 230.

As described above, the association of the identifier of the second data shard 236-1 to the first data shard 234-1 is triggered based on the monitoring engine 216. The monitoring engine 216 may trigger the above described steps in response to determining that the state of the data within the first data shard 234-1 meets the conditions provided in the metadata information 226. In an example, the monitoring engine 216 may be implemented using a machine learning model to monitor different dimensions. Such a machine learning model, to such an end, may be trained based on prior instances of such dimensions. For example, the monitoring engine 216 may, based on past instances when a certain volume of data incoming data was received, may affect refreshing of data when such a threshold volume of incoming data from the data sources 238 is detected. In such an example, the monitoring engine 216 may be initially trained based on training data corresponding to parameters associated with the state of the data within the first data shard 234-1. In such a case, metadata information 226 may not be provided.

In another example, the data access engine 214 may monitor whether the association of the identifier of the second data shard 236-1 to the first data shard 234-1 is completed or not. On determining that the first data shard 234-1 could not be renamed based on the identifier of the second data shard 236-1, or if the processes times out, the data access engine 214 may restore the second data shard 236-1. This may be performed in cases where any disruption occurs, example in cases of outages.

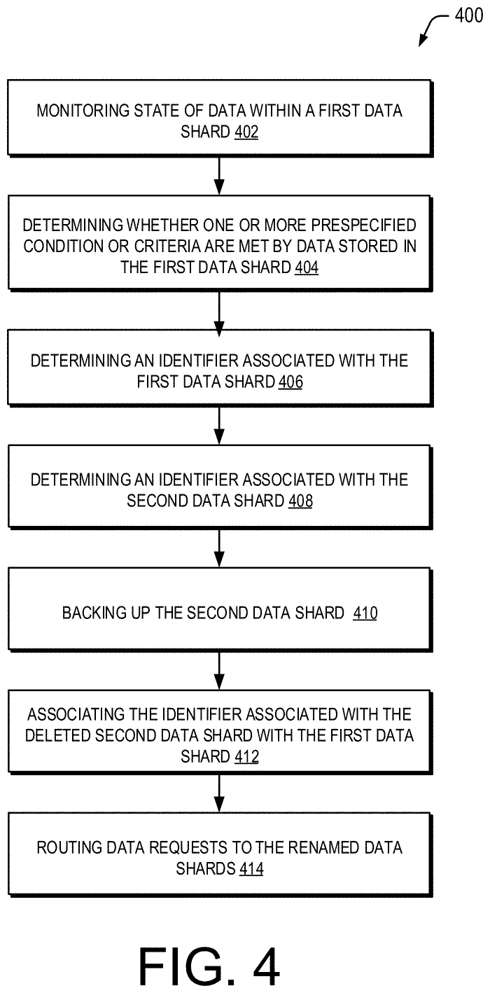

FIG. 4 illustrates a method 400 for managing requests to data shards, as per an example. Although the method 400 may be implemented in a variety of computing devices, for the ease of explanation, the present description of the example method 400 is provided in reference to the above-described data systems 100 and 202 (collectively referred to as systems 100, 202).

The order in which the method 400 is described is not intended to be construed as a limitation, and any number of the described method blocks may combine in any order to implement the method 400, or an alternative method. It may be understood that the blocks of the method 400 may be performed by any one of the devices 100, 202. The blocks of the method 400 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 402, state of data within a first data shard may be monitored. For example, the monitoring engine 216 may monitor the first data shard 234-1, which is one of the data shards within the first set 230. As described earlier, the first set 230 is in communication with one or more data sources 238 from which data may be continuously sourced and stored within the first data shard 234-1. In the present example, the first data shard 234-1 may be monitored based on one or more conditions or rules stored in the metadata information 226. Monitoring the state of the data within the first data shard 234-1 may entail evaluating the amount of data stored or evaluating incoming data from one or more of the data sources 238 based on one or more criteria.

At block 404, it may be determined whether one or more pre-specified condition or criteria are met by data stored in the first data shard. For example, the monitoring engine 216 may determine whether any one or more of the specified conditions in the metadata information 226 are met by the data stored in the first data shard 234-1. Example of such criteria may include, but are not limited to, volume of data, certain attributes of data, frequency at which data is being updated within the first data shard 234-1, and such. It may be noted that any other parameters may also be considered without deviating from the scope of the present subject matter.

At block 406, an identifier associated with the first data shard may be determined. In an example, the data access engine 214 may obtain the identifier corresponding to the first data shard 234-1. In an example, the identifier of the first data shard 234-1 may be obtained from the shard identifiers 220. In a similar manner, at block 408, an identifier associated with a second data shard within a second set of data shards may be determined. As described previously, data requests from one or more users received over a network are executed and processed on the second set of data shards. One or more data shards within the second set of data shards corresponds to one or more data shards within the first set of the data shards. Returning to the present example, the data access engine 214 may obtain the identifiers corresponding to the second data shard 236-1 from the shard identifiers 220.

At block 410, the second data shard may be backed up. For example, on obtaining the shard identifiers 220 of the first data shard 234-1 and the second data shard 236-1, the data access engine 214 may back up the second data shard 236-1. In an example, the data access engine 214 may delete the second data shard 236-1 once the same has been backed up

At block 412, the identifier associated with the deleted second data shard is associated with the first data shard. For example, the data access engine 214 may obtain the identifier corresponding to the second data shard 236-1 (which is now deleted) and associates the same with the first data shard 234-1. In an example, the first data shard 234-1 with the identifier of the previously available second data shard 236-1 may then be logically included as part of the second set 232. The first data shard 234-1 which is now renamed based on the identifier of the second data shard 236-1, is depicted as data shard 234′ (as illustrated in FIG. 3B).

At block 414, data requests may be routed to the renamed data shards. For example, the data access engine 214 may begin routing data requests to the renamed data shard 234′. As may be understood, the data shard 234′ (which bears the identifier of the previously present second data shard 236-1) includes data which is updated when considered with respect to the data which was available within the second data shard 236-1. In this manner, data within any one or more of the second set 232 may be updated based on the data which may have been continuously collected in the data shards of the first set 230.

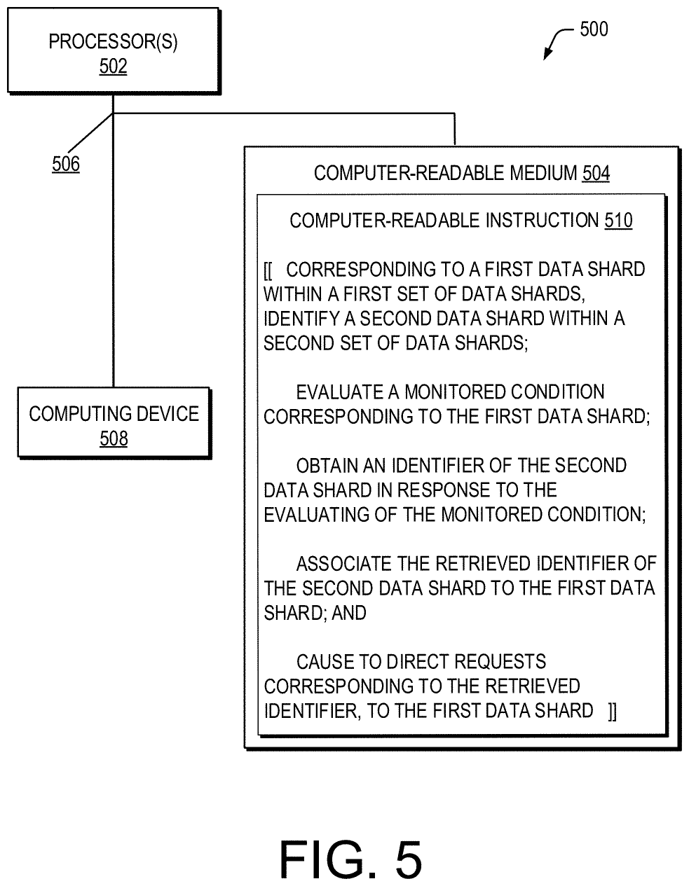

FIG. 5 illustrates a computing environment 500 implementing a non-transitory computer readable medium for managing data requests to a data shard. In an example, the computing environment 500 includes processor(s) 502 communicatively coupled to a non-transitory computer readable medium 504 through communication link 506. In an example, the computing environment 500 may be for managing data requests to data shards by a data system 202, as depicted in FIG. 2. In an example, the processor(s) 502 may have one or more processing resources for fetching and executing computer-readable instructions from the non-transitory computer readable medium 504. The processor(s) 502 and the non-transitory computer readable medium 504 may be implemented, for example, in systems 100, 202.

The non-transitory computer readable medium 504 may be, for example, an internal memory device or an external memory. In an example implementation, the communication link 506 may be a network communication link, or other communication links or communication interfaces. The processor(s) 502 and the non-transitory computer readable medium 504 may also be communicatively coupled to a computing device 508 over the network. The computing device 508 may be implemented, for example, as system 100, 202. In an example implementation, the non-transitory computer readable medium 504 includes a set of computer readable instructions 510 which may be accessed by the processor(s) 502 through the communication link 506 and subsequently executed to perform acts for feature-based reporting of software versions.

Referring to FIG. 5, in an example, the non-transitory computer readable medium 504 includes computer readable instructions 510 that cause the processor(s) 502 to identify, corresponding to a first data shard within a first set of data shards, a second data shard within a second set of data shards. In an example, the data access engine 214 may identify the second data shard 236-1 present within the second set 232. In the present example, the second data shard 236-1 may correspond to the first data shard 234-1. Once identified, the instructions 510 when executed may evaluate whether a monitored condition corresponding to the first data shard 234-1 has been met. On determining that the condition of data within the first data shard 234-1 matches the monitored conditions, the instructions 510 when executed may result in obtaining an identifier corresponding to the second data shard, i.e., the second data shard 236-1. Thereafter, the instructions 510 may cause the identifier associated within the second data shard 236-1 to be associated with the first data shard 234-1. This results in renaming the first data shard 234-1 based on the identifier of the second data shard 236-1. With the first data shard 234-1 now renamed based on the identifier of the second data shard 236-1, the instructions 510 may cause one or more data requests to be redirected to the first data shard 234-1 (which is now renamed based on the identifier of the second data shard 236-1).

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

What is claimed is:

1. A data system comprising:
a processor;
a data access engine coupled to the processor, wherein the data refreshing module is to:
corresponding to a first data shard within a first set of data shards, identify a second data shard within a second set of data shards;
evaluate a monitored condition corresponding to the first data shard;
retrieve an identifier of the second data shard in response to the evaluating of the monitored condition;
associate the retrieved identifier of the second data shard to the first data shard; and
cause to direct requests corresponding to the retrieved identifier, to the first data shard.

2. The data system as claimed in claim 1, wherein the second data shard is identified based on a shard mapping, wherein the shard mapping is to associate an identifier of the second data shard to a data attribute of data stored within the second data shard.

3. The data system as claimed in claim 1, wherein the data access engine is to evaluate the monitored condition based on one of a threshold volume of data within the first data shard, type of data, and frequency of data being updated in the first data shard.

4. The data system as claimed in claim 1, wherein the data access engine is to evaluate the monitored condition based on machine learning model, with the machine learning model being trained on a training data set representing at least one of the monitored conditions.

5. The data system as claimed in claim 1, wherein on associating the retrieved identifier of the second data shard to the first data shard, the data access engine is to cause backing up of the second data shard.

6. The data system as claimed in claim 1, wherein the data shards in one of the first set of data shards and the second set of data shards are based on a predefined criteria.

7. The data system as claimed in claim 1, wherein the first set of data shards are coupled to a plurality of data sources from which data is periodically received.

8. The data system as claimed in claim 1, wherein each of the data shards within the first set of data shards correspond to another data shard within the second set of data shards.

9. The data system as claimed in claim 1, wherein one of the first data shard and the second data shard further comprises a plurality of sub-shards.

10. A method comprising:
monitoring incoming data being stored in a first data shard within a first set of data shards;
based on the monitoring, identifying a second data shard within a second set of data shards, wherein the second data shard corresponds to the first data shard;
associating an identifier of the second data shard to the first data shard; and
causing to direct requests corresponding to the retrieved identifier, to the first data shard.

11. The method as claimed in claim 10, further comprising identifying a second data shard based on a shard mapping, wherein the shard mapping is to map an identifier of the second data shard to a data attribute of data stored within the second data shard.

12. The method as claimed in claim 10, wherein the monitoring is based on one of a threshold volume of data within the first data shard, type of data, and frequency of data being updated in the first data shard.

13. The method as claimed in claim 10, further comprising backing up of the second data shard on associating the identifier of the second data shard to the first data shard.

14. The method as claimed in claim 10, wherein the data shards in one of the first set of data shards and the second set of data shards are based on a predefined criteria.

15. The method as claimed in claim 10, wherein the first set of data shards are coupled to a plurality of data sources from which data is periodically received.

16. The method as claimed in claim 10, wherein each of the data shards within the first set of data shards correspond to another data shard within the second set of data shards.

17. A non-transitory computer-readable medium comprising computer readable instructions, which when executed by a processing unit, causes a computing system to:
corresponding to a first data shard within a first set of data shards, identify a second data shard within a second set of data shards;
evaluate a monitored condition corresponding to the first data shard;
obtain an identifier of the second data shard in response to the evaluating of the monitored condition;
associate the retrieved identifier of the second data shard to the first data shard; and
cause to direct requests corresponding to the retrieved identifier, to the first data shard.

18. The non-transitory computer-readable medium as claimed in claim 17, wherein the instruction when executed are to further result in identifying the second data shard based on a shard mapping, wherein the shard mapping is to associate an identifier of the second data shard to a data attribute of data stored within the second data shard.

19. The non-transitory computer-readable medium as claimed in claim 17, wherein the instructions are to cause to evaluate the monitored condition based on one of a threshold volume of data within the first data shard, type of data, and frequency of data being updated in the first data shard.

20. The non-transitory computer-readable medium as claimed in claim 17, wherein the instructions are to cause deletion of the second data shard on associating the identifier of the second data shard to the first data shard.
